(19) United States
(12) Patent Application Publication
(10) Pub. No.: US 2026/0352486 A1
(43) Pub. Date: Nov. 5, 2026

(54) Electronic device and method for verifying a set of avionics computer files to be transmitted to at least one avionics system, related installation and computer program

(71) Applicant: THALES, Meudon (FR)

(72) Inventors: Fabien VITTOZ, TOULOUSE CEDEX 1 (FR); Fabien KUNTZ, TOULOUSE CEDEX 1 (FR); Loïc CHACORNAC, TOULOUSE CEDEX 1 (FR); Alexis PERNOT, TOULOUSE CEDEX 1 (FR)

(21) Appl. No.: 19/663,268

(22) Filed: Apr. 30, 2026

(30) Foreign Application Priority Data
Apr. 30, 2025 (FR) 2504594

(51) Int. Cl. H04L 9/32

(52) U.S. Cl. CPC H04L 9/3247

(57) ABSTRACT

An electronic verification device for a set of avionics computer file(s) to be transmitted to at least one avionics system and to be received from at least one electronic apparatus, the device including a verification module, configured to obtain the set, to verify at least one signature per file of the set and to generate an alert message in the event of non-verification of the signature of at least a part of the set, a storage module, configured to store at least one portion of the set if the signature verification of the at least one portion has been successfully performed, and a transmission module, configured to transmit the at least one portion, to the at least one avionics system, if the signature verification of the at least one portion has been successfully performed.

### REFERENCE TO RELATED APPLICATIONS

This application is a U.S. non-provisional application claiming the benefit of French Patent Application No. 25 04594 filed on Apr. 30, 202e, the contents of which are incorporated herein by reference in their entirety.

### TECHNICAL FIELD OF THE INVENTION

The present invention relates to an electronic device for verifying a set of avionics computer files intended to be transmitted to at least one onboard avionics system installed onboard an aircraft, the files being able to be received from at least one electronic device, the verification device being separate from the at least one electronic device and configured to be connected to the at least one electronic device, the verification device and the at least one electronic device being external to the aircraft.

The present invention also relates to an installation including an electronic verification device of the aforementioned type, a verification method using an electronic verification device of the aforementioned type, and a non-transitory computer-readable medium including a computer program including software instructions that implement such a method, when executed by a computer.

### BACKGROUND OF THE INVENTION

The invention relates to the field of cyber-security in aeronautics, and in particular to the secure transmission of avionics computer files to one or more avionics systems installed onboard an aircraft.

Indeed, it is regularly necessary to import computer files onto avionics systems installed onboard an aircraft. In particular, maintenance files must regularly be downloaded onto such avionics systems.

In order to transmit maintenance files to an aircraft, it is known to use portable access terminals intended for maintenance, or PMAT (Portable Maintenance Access Terminal). These are generally laptops belonging to the airline.

The maintenance files are software packages available for download on the website, also called FLS (Field Loadable Software) files, for example.

Typically, a maintenance operator must burn the FLS files onto a CD-ROM from the maintenance operations center, then download these files onto the PMAT via the CD-ROM.

Then, a first option is to connect a cable between the PMAT and a maintenance socket of the aircraft, then use preinstalled software on the PMAT to perform an update according to the ARINC 615A standard.

A second option is to connect a compact flash card reader to the PMAT, use the same preinstalled software on the PMAT, which then transfers the FLS files onto a compact flash card, then insert the compact flash card into an avionics system to be updated.

In both cases, the PMAT may be compromised by an attacker who would replace the PMAT maintenance software with a malicious version, or install malware on the PMAT. The feared event is alteration of the FLS files, with an impact on the integrity of the FLS files potentially calling into question the safety of the aircraft.

To address this vulnerability, the PMAT is generally disconnected from the network and isolated in a secure location, which often prevents updating the PMAT computer system and the preinstalled software.

A recently used solution is to strengthen the PMAT cyber security via hardening of an operating system, or OS (Operating System), equipping the PMAT, and a verification of the integrity and authenticity of the OS and software applications installed on the PMAT.

However, these methods are not fully satisfactory.

### SUMMARY OF THE INVENTION

One objective of the invention is therefore to propose an electronic device for verifying computer files that is easy to use, providing strong cyber security for the files transmitted to the aircraft and compatible with external PMAT-type equipment.

To this end, the invention relates to an electronic device for verifying a set of avionics computer files intended to be transmitted to at least one onboard avionics system installed onboard an aircraft, the files being able to be received from at least one electronic device, the verification device being separate from the at least one electronic device and configured to be connected to the at least one electronic device, the verification device and the at least one electronic device being external to the aircraft, the verification device including:
a verification module, configured to obtain the set of avionics computer file(s) from the at least one electronic device, to verify at least one signature per avionics computer file of the set, and to generate an alert message in the event of non-verification of the signature of at least a part of the set of avionics computer file(s);
a storage module, configured to store at least one portion of the set of avionics computer file(s), in a storage memory of the verification device, if the signature verification of the at least one portion of the set of avionics computer file(s) has been successfully performed; and
a transmission module, configured to transmit the at least one portion of the set of avionics computer file(s), to the at least one avionics system, if the signature verification of the at least one portion of the set of avionics computer file(s) has been successfully performed.

By using the verification module and the distinction between the electronic verification device and the at least one electronic device, possible compromise of the at least one electronic device will not affect the verification device and/or the at least one avionics system. This makes it possible to remove the organizational measures taken to secure the electronic device according to the prior art, such as the requirement prohibiting connection of the PMAT to the ethernet network, which is not always rigorously applied. In particular, the electronic verification device according to the invention makes it possible to authorize a connection of the electronic device to a wireless network, while ensuring the cyber-security of the at least one avionics system.

According to other advantageous aspects of the invention, the verification device includes one or more of the following features, taken alone or in any technically possible combinations:
the verification, storage and transmission modules are included in a secure enclave within the verification device;
the electronic verification device further includes a filtering module, configured to filter data received from the at least one electronic device;
the verification module is configured to verify the signature of the set of avionics computer file(s) via an asymmetric cryptography algorithm;
the verification device includes a computer medium reader and a protective housing inside which the verification, storage and transmission modules are arranged, the reader being removable relative to the protective housing;
the reader preferably being a compact flash type of medium reader;
the verification device includes a processor of a type different from a processor equipping the at least one electronic device, the processor type being chosen from the group including: x86, ARM®, PowerPC; and
the verification device includes an operating software system of a type different from an operating software system equipping the at least one electronic device, the operating software system type being chosen from the group including Windows, Linux or MacOS.

The invention also relates to an installation for transmitting a set of avionics computer file(s) to at least one onboard avionics system installed onboard an aircraft, the transmission installation including at least one electronic device and an electronic verification device connected to the at least one electronic device, the verification device being as defined above.

According to another advantageous aspect of the invention, the transmission installation includes the following feature:
the or each electronic device is a portable terminal, intended for maintenance support.

The invention also relates to a method for verifying a set of avionics computer file(s) transmitted by at least one electronic device to at least one onboard avionics system on board an aircraft including the following operations:
acquisition of the set of avionics computer file(s);
signature verification of the set of avionics computer file(s);
in the event of failure of signature verification of at least a part of the set of avionics computer file(s), generation of an alert message; and
in the event of success of signature verification of at least a portion of the set of avionics computer file(s), the storing of the at least one portion of the set of avionics computer file(s); then transmission of the at least one portion of the set of avionics computer file(s) to one or more onboard avionics systems on board an aircraft.

The invention also relates to a non-transitory computer-readable medium including a computer program, including software instructions that implement a verification method as defined above when executed by a computer.

### BRIEF DESCRIPTION OF THE DRAWINGS

These features and advantages of the invention will appear more clearly on reading the following description, given solely by way of non-limiting example, and made with reference to the appended drawings, wherein:

FIG. 1 is a schematic representation of an installation, according to the invention, for transmitting avionics computer files to at least one onboard avionics system installed onboard an aircraft, the transmission installation including at least one electronic device and an electronic verification device connected to the at least one electronic device; and

FIG. 2 is a flowchart of a method for verifying computer files by the verification device of FIG. 1, according to the invention.

### DETAILED DESCRIPTION OF THE INVENTION

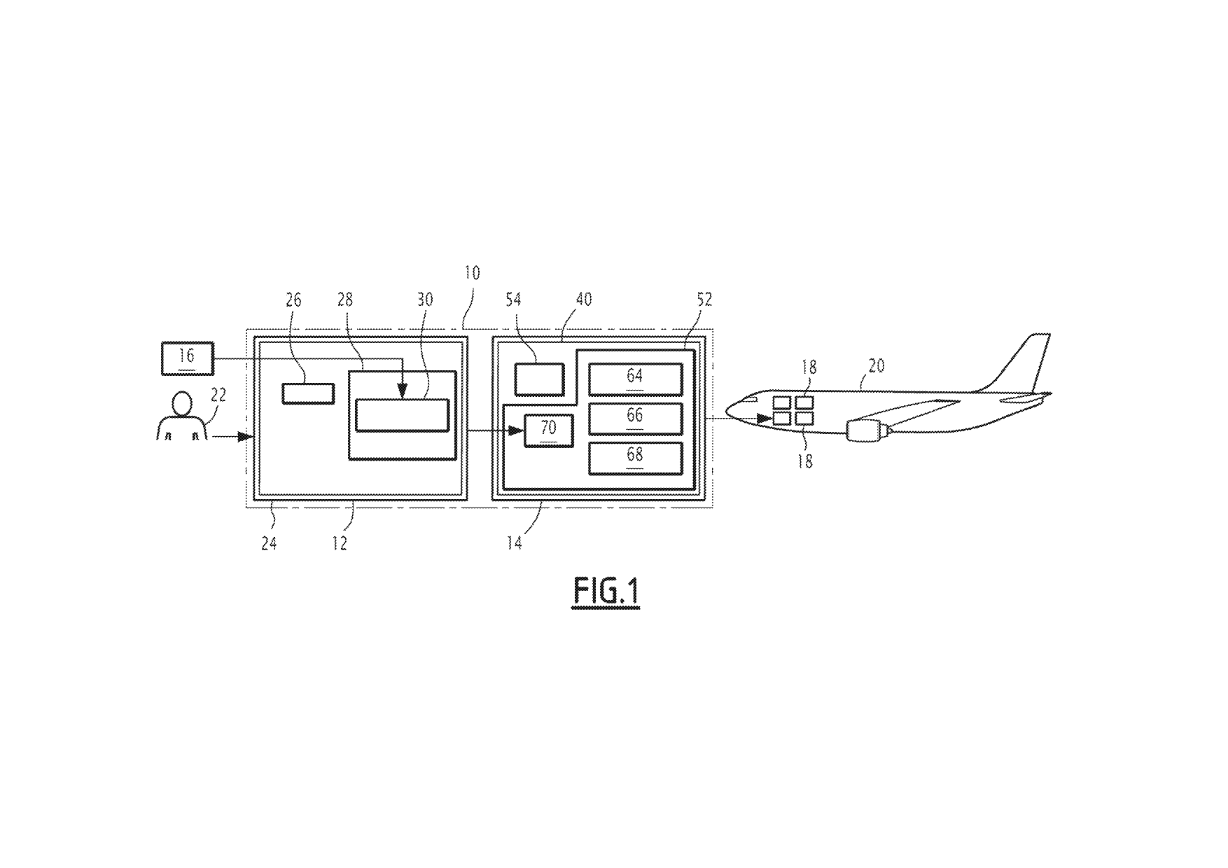

In FIG. 1, a transmission installation 10 includes an electronic apparatus 12 and an electronic verification device 14 configured to receive a set 16 of computer files transmitted by electronic apparatus 12. Electronic verification device 14 is also configured to transmit set 16 of computer files to one or more onboard avionics systems 18 installed onboard an aircraft 20.

Electronic verification device 14 is separate from electronic apparatus 12 and is connected to electronic apparatus 12. Electronic verification device 14 and electronic apparatus 12 form two physically separate pieces of electronic equipment.

Electronic apparatus 12 is configured to be controllable by a maintenance operator 22.

Electronic apparatus 12 is a laptop, for example, belonging to an airline, for example, and further includes an ethernet port and a USB-C port. Optionally, electronic apparatus 12 also includes a CD-ROM reader and a USB port.

Electronic apparatus 12 includes a first information processing unit 24, including a first memory 26 and a first processor 28 associated with first memory 26. It further includes an operating system, which is a Windows^{®} or MacOS^{®} environment, for example. For example, first processor 28 has an x86-64-bit Windows^{®} architecture.

The operating system includes a module 30 that gives access to a user space, stored in first memory 26, and an input/output controller.

The user space further includes a browser that has access to external data, in particular via a wireless internet access or via a wired access to an internal network. In the preferred embodiment, the browser includes wireless internet access.

The browser makes it possible to install software for updating applications present in the operating system and software for updating the operating system.

The browser also makes it possible to install set 16 of computer files intended to be transmitted to one or more onboard avionics systems 18.

Access to the browser is a feature of module 30 that gives access to the user space.

Advantageously, set 16 of computer file(s) is a set of maintenance file(s), and one or more FLS files, for example.

In a variant or in addition, the or one of the computer file(s) is software or a part of software.

In a variant or in addition, the or one of the computer file(s) is a database.

Set 16 includes one or more computer files.

Verification device 14 includes a second information processing unit 40. Second information processing unit 40 is typically composed of a second memory 52 and a second processor 54 associated with second memory 52.

Verification device 14 also includes, for example, a compact flash type of medium reader, an input/output controller, an ethernet port and a USB-C port.

Second processor 54 is of a type different from first processor 28 and is provided with an operating system different from the operating system of first processor 28.

Second processor 54 is an ARM^{®} or PowerPC^{®} processor with an embedded operating system of the Linux^{®} type, for example.

Verification device 14 includes a module 64 for verifying at least one computer file intended for an avionics system 20, a module 66 for storing each respective computer file acquired, and a module 68 for transmitting each computer file validated by verification module 64 and stored by storage module 66 to the corresponding avionics system 20, transmission module 68 being connected downstream of storage module 66, the latter being connected downstream of verification module 64.

Verification module 64 is capable of receiving set 16 of computer files and performing a signature verification of the avionics computer files.

The signature verification is intended to verify the integrity, authenticity and/or non-repudiation of the avionics computer files.

Authenticity of a computer file means the fact that the computer file was issued by a certified producer of computer files.

Integrity of a computer file means that the information carried by the computer file has not been modified, altered or deleted, in part or in full, after its creation, nor has any additional information been added to it after its creation.

Non-repudiation of a computer file means that an action on the computer file carried out in the name of a supplier of the computer file, after authentication, cannot be repudiated by the latter.

As an optional addition, verification module 64, storage module 66 and transmission module 68 are included in a secure enclave.

Secure enclave 50 is a hardware enclave, for example, which means that verification module 64, storage module 66 and transmission module 68 are executed on dedicated hardware resources, i.e., an isolated processor, for example.

In this case, secure enclave 50 is, for example, a Trusted Execution Environment, or TEE. The secure client enclave is chosen from the group consisting of an ARM^{®} TrustZone^{®} enclave and an Intel^{®} Software Guard Extensions enclave, also called Intel^{®} SGX, for example.

In a variant, secure enclave 50 is a logical enclave, which means that verification device 14 has software mechanisms so that other software applications of verification device 14 do not access verification module 64, storage module 66 or transmission module 68.

For example, second processor 54 has time windows during which it dedicates its resources exclusively to verification module 64, storage module 66 and transmission module 68.

Reception of set 16 of computer files is preferably performed via a wired connection, such as a USB-C input connected to electronic apparatus 12.

Advantageously, verification device 14 further includes a filtering module 70 configured to filter access to verification device 14 by electronic apparatus 12.

Filtering module 70 is connected downstream of the USB-C input, for example, and verification module 64 is connected downstream of filtering module 70.

Advantageously, filtering module 70 includes several elements that make it possible to protect access to verification device 14: a firewall, syntactic filtering and a protocol break, for example.

Advantageously, the USB-C input makes it possible to ensure power supply to verification device 14.

Verification module 64 is implemented in the form of a DataLoader-type application, for example.

Integrity and authenticity of set 16 of computer files are verified via implementation of a signature verification function, for example.

This signature verification uses an asymmetric cryptography algorithm, for example. A public key will be installed in the maintenance housing and will serve the signature verification application. An associated private key is stored on the signatory side.

The asymmetric cryptography algorithm is an RSA-type algorithm, for example. When creating an FLS file, a fingerprint with the SHA256 algorithm is calculated. The signature relies on calculating this fingerprint via an RSA-type algorithm with a 4096-bit key. The result is stored with the FLS by ZIP-format compression of the FLS file and the signature, for example, and will be transmitted to verification module 64. Signature verification in verification module 64 consists of decrypting the signature with the public key to extract the trusted fingerprint and compare it with the FLS fingerprint calculated in parallel.

In a variant, the cryptography algorithm uses an elliptic curve cryptography method, of the ECDSA (Elliptic Curve Digital Signature Algorithm) type, for example.

As a further variant, signature verification uses the ARINC 835 format.

Transmission module 68 is capable of communicating with onboard avionics system 18 according to the ARINC 615A protocol, for example.

In a variant or in addition to the ARINC 615A protocol, the ARINC 615 protocol is used, if an ARINC 429 type of connection is used, for example.

Verification module 64, storage module 66 and transmission module 68 are each implemented in the form of software, for example, or a software building block, executable by second processor 54. Second memory 52 of verification device 14 is then capable of storing software for acquiring at least one computer file intended for avionics system 20, software for verifying each respective acquired computer file and transmission software, intended for the corresponding avionics system 20, for each computer file validated by the verification software and stored by the storage software. Second processor 54 of verification device 14 is then capable of executing each of the software of the acquisition software, the verification software and the transmission software.

Aircraft 20 includes avionics systems 18 installed onboard. Aircraft 20 is preferably an airplane. In a variant, aircraft 20 is a helicopter or a drone piloted remotely by a user.

Each onboard avionics system 18 is, for example, chosen from the group including a flight management system (FMS), a flight guidance system (FG), a flight control system (FCS), a global navigation satellite system (GNSS) such as a global positioning system (GPS), an inertial reference system (IRS), an instrument landing system (ILS) or a microwave landing system (MLS), a Runway Overrun Prevention System active runway overrun prevention system (ROPS) and a radio altimeter (RA).

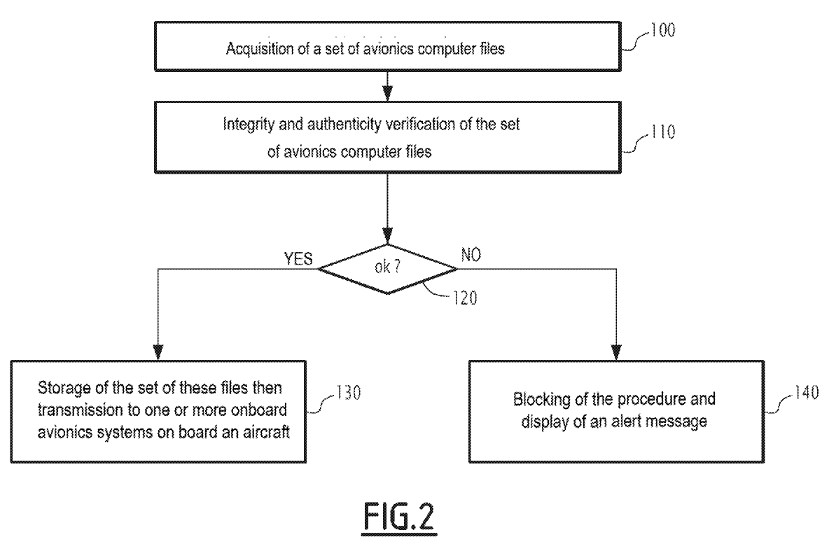

Operation of verification device 14 according to the invention will now be described with reference to FIG. 2, which shows a flowchart of the method for verifying one or more computer files, the verification method being implemented by verification device 14.

Once acquired by electronic apparatus 12, set 16 of computer files may be transmitted to verification device 14.

During an acquisition operation 100, verification device 14 acquires set 16 of computer files from electronic apparatus 12.

Transmission of set 16 of computer files to verification device 14 is preferably performed by USB-C cable.

Operation 100 is implemented by verification module 64.

Then, during a verification operation 110, verification module 64 proceeds with verification of set 16 of computer files.

Then, during a test operation 120, a test result is determined by verification module 64. The test result is positive (YES) if, during verification operation 110, verification of set 16 of computer file(s) is correct. The test result is negative (NO) if, during verification operation 110, verification of at least a part of set 16 of computer file(s) is incorrect.

At least a part of a set designates only a part of the set or the whole set, i.e., all or part of the set. Similarly, at least a portion of a set designates only a portion of the set or the whole set, i.e., all or part of the set.

Thereafter, the notions of part and portion are equivalent, and simply indicate two distinct terminologies to distinguish the share of files, each authentic and intact, from the share of files, each non-authentic and/or non-intact.

For example, verification of at least a part of set 16 of computer file(s) is incorrect while verification of at least a portion of set 16 of computer file(s) is correct.

According to a first variant, verification of set 16 of computer file(s) is performed sequentially for the or each computer file, the or each computer file having an individual signature, for example.

According to a second variant, verification of set 16 of computer file(s) is performed as a block for set 16 of computer file(s), set 16 of computer file(s) having a unique signature, for example.

According to a third variant, verification of set 16 of computer file(s) is performed, for a first part of set 16 of computer file(s), sequentially for the or each computer file, the or each computer file having an individual signature, for example, and then is performed, for a second part of set 16 of computer file(s), by block(s) of computer files, a block of computer files having a unique signature, for example.

If the result of test operation 120 is positive (YES), set 16 of computer file(s) is then intended to be stored by storage module 66 on second memory 52 during a storage and transmission operation 130. During this storage and transmission operation 130, set 16 of computer file(s) is transmitted by transmission module 68 to onboard avionics system(s) 18 of aircraft 20, for which set 16 is intended.

If the result of test operation 120 is negative (NO), i.e., verification of the authenticity or integrity of at least a part of set 16 of computer file(s) is incorrect, the verification method includes an operation 140 of generating an alert message that will be raised to operator 22.

In a variant, if set 16 of computer file(s) includes several computer files independent of each other and the result of test operation 120 is negative (NO) for set 16 of computer files, but verification of authenticity or integrity of a portion of set 16 of computer file(s) is correct, generation operation 140 further includes an operation of storing and transmitting the portion of set 16 of computer file(s) whose authenticity or integrity verification is correct.

Advantageously, the alert message is configured to be transmitted to a screen visible by operator 22 and to be displayed by the screen.

Preferably, generation operation 140 further includes saving the at least one part of set 16 of computer file(s) whose integrity or authenticity verification is incorrect for the purposes of later investigation.

The at least one electronic apparatus 12 is capable of being connected to external networks, and is therefore vulnerable to attacks and potentially compromised.

However, the physical dissimilarity between first processor 28 of the at least one electronic apparatus 12 and second processor 54 of verification device 14 makes possible compromise of verification device 14 from the at least one electronic apparatus 12 more difficult.

Indeed, malware on an x86-64 system will not run on an ARM system, for example.

The software dissimilarity between the operating systems of the at least one electronic apparatus 12 and of verification device 14 also makes possible compromise of verification device 14 from the at least one electronic apparatus 12 more difficult.

In addition, the attack surface is reduced to one input of verification device 14, such as USB-C, through which verification device 14 is connected to the at least electronic apparatus 12, and this is protected by verification module 64 contained in secure enclave 50.

Trust is therefore stronger than in a single potentially compromised system in which the signature verification could have been bypassed.

Furthermore, this protection system makes it possible to remove the organizational measures usually implemented to secure the at least electronic apparatus 12, which is usually placed in a vault, for example.

In particular, this protection system makes it possible to connect the at least electronic apparatus 12 to a wireless network. This at least electronic apparatus 12 is an airline laptop, for example, and requires regular updates of its operating system.

1. An electronic verification device for verifying a set of avionics computer file(s) destined to be transmitted to at least one avionics system installed onboard an aircraft, the file(s) being able to be received from at least one electronic apparatus, the verification device being separate from the at least one electronic apparatus and connected to the at least one electronic apparatus, the verification device and the at least one electronic apparatus being external to the aircraft, the verification device comprising:
a verification module, obtaining the set of avionics computer file(s) from the at least one electronic apparatus, to verify at least one signature for each avionics computer file of the set and to generate an alert message in case of non-verification of the signature of at least a part of the set of avionics computer file(s);
a storage module, storing at least one portion of the set of avionics computer file(s) in a storage memory of the verification device, if the signature verification of the at least one portion of the set of avionics computer file(s) has been successfully performed; and
a transmission module, transmitting the at least one portion of the set of avionics computer file(s) to the at least one avionics system, if the signature verification of the at least one portion of the set of avionics computer file(s) has been successfully performed.

2. The device according to claim 1 wherein said verification module, said storage module and said transmission module are included in a secure enclave within the verification device.

3. The device according to claim 1 further comprising a filtering module configured to filter data received from the at least one electronic apparatus.

4. The device according to claim 1 wherein said verification module verifies the signature of the set of avionics computer file(s) via an asymmetric cryptography algorithm.

5. The device according to claim 1 further comprising:
a computer medium reader; and
a protective housing inside which said verification, storage and transmission modules are arranged, said reader being removable relative to the protective housing.

6. The device according to claim 5 wherein said reader is a compact flash type of medium reader.

7. The device according to claim 1 further comprising a processor of a type different from a processor equipping the at least one electronic apparatus, the processor type being chosen from the group comprising x86, ARM^{®} or PowerPC.

8. The device according to claim 1 further comprising an operating software system of a type different from an operating software system equipping the at least one electronic apparatus, the operating software system type being chosen from the group comprising Windows, Linux or MacOS.

9. A transmission installation for transmitting a set of avionics computer file(s) to at least one avionics system installed onboard an aircraft, comprising:
at least one electronic apparatus; and
an electronic verification device connected to said at least one electronic apparatus, the verification device being according to claim 1.

10. The installation according to claim 9 wherein each of said at least one electronic apparatus is a Portable Maintenance Access Terminal.

11. A verification method by a verification device of a set of avionics computer file(s) transmitted by at least one electronic device to at least one avionics system installed onboard an aircraft comprising:
acquiring the set of avionics computer file(s);
signature verifying the set of avionics computer file(s);
in the event of failure of signature verification of at least a part of the set of avionics computer file(s), generating an alert message; and
in the event of success of signature verification of at least a portion of the set of avionics computer file(s):
storing the at least one portion of the set of avionics computer file(s); and
transmitting the at least one portion of the set of avionics computer file(s) to one or more onboard avionics systems on board an aircraft.

12. A non-transitory computer-readable medium including a computer program, including software instructions that implement a method according to claim 11 when executed by a computer.
